(19) United States
(12) Patent Application Publication
(10) Pub. No.: US 2023/0050474 A1
(43) Pub. Date: Feb. 16, 2023

(54) KNIFE BLADE

(71) Applicant: Brothers Brands, Inc., Westwood, NJ (US)

(72) Inventor: Jordan Schmidt, Westwood, NJ (US)

(21) Appl. No.: 17/454,675

(22) Filed: Nov. 12, 2021

Related U.S. Application Data
(63) Continuation of application No. 29/788,891, filed on Aug. 10, 2021.

(51) Int. Cl. B26B 9/00

(52) U.S. Cl. CPC B26B 9/00

(57) ABSTRACT

A reduced friction knife blade includes the implementation of air gaps of different air volumes or shapes on opposing sides of blade such that food items cannot stick to the same. The different air volumes of the air gaps are formed such that they extend all the way to the top edge of the knife blade.

### CROSS REFERENCE TO RELATED APPLICATIONS

This application is a continuation of U.S. Design Patent Application Ser. No. 29/788,891 filed on Aug. 10, 2021.

### BACKGROUND

### Technical Field

The present invention relates to knives. More particularly, it relates to friction reducing knife blade and the configuration of the same for use in food preparation.

### Description of Related Art

Friction reduced knife blades generally use a preferred metal material, special coatings or in some cases, scalloped gaps or enclosed indentations are cut into the side of the knife blade in an effort reduce the friction or drag resulting from a food product being sliced by the blade. Enclosed indentations and/or flat blade no matter how sharp have a drawback in that when the food product is sliced and travels along the knife blade, the organic material from the food product can cause the food product to stick to the blade through the entire slicing action, and in the case of indentations, a vacuum is created between the food product and the indentation which also operates to retain the food product on the knife blade rather than offer a reduced friction or reduced drag between the food product and the knife blade.

### SUMMARY OF THE INVENTION

In accordance with one embodiment, the knife includes a blade having opposing sides, a top edge and a cutting edge. A first plurality of air gaps are formed on one of the opposing sides and are slightly spaced from the cutting edge. Some of the first plurality of air gaps have different shapes relative to others of said first plurality of air gaps. Each of the first plurality of air gaps extend all the way to the top edge. A second plurality of air gaps are formed in the other of the opposing sides and are also slightly spaced from the cutting edge. Some of the second plurality of air gaps have different shapes relative to others of the second plurality of air gaps and all of the second plurality of air gaps have different shapes relative to the first plurality of air gaps. The plurality of second air gaps extending all the way to the top edge.

According to another implementation, the knife includes a blade having a first side and a second opposing side, a cutting edge and a top edge. A first set of depressions are formed in the first side. The first set of depressions are separated by raised peaks which forming first air gaps having a first air volume. A second set of depressions are formed in the first side. The second set of depressions are dispersed among the first set of depressions and are also separated by the raised peaks. The second set of depressions form second air gaps having a second air volume that is different than the first air volume. A first set of protrusions are formed on the second side. The first set of protrusions are separated by depressed points. The depressed points between the first set of protrusions form third air gaps having a third air volume that is different than both the first air volume and second air volume. A third set of depressions are formed in the second side and are dispersed among the first set of protrusions and are also separated by the depressed points of adjacent first protrusions. The third depressions form fourth air gaps having a fourth air volume that is different than the first air volume, the second air volume and the third air volume.

According to a further implementation, the knife includes a blade having a first side and a second opposing side, a cutting edge and a top edge. First air gaps are formed on the first side and extend to the top edge. Each of the first air gaps having a first air volume. Second air gaps are also formed on the first side and extend to the top edge. Each of the second air gaps have a second air volume. The second air volume is different than the first air volume. Third air gaps are formed on the second side and extend to the top edge. Each of the third air gaps having a third air volume. Fourth air gaps are formed on the second side and extend to the top edge. Each of the fourth air gaps having a fourth air volume. The fourth air volume being different than the third air volume.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a perspective view of the reduced friction knife blade according to an embodiment of the invention;

FIG. 2 is a left side view of the reduced friction knife blade according to an embodiment of the invention;

FIG. 3 is a right side view of the reduced friction knife blade according to an embodiment of the invention;

FIG. 4A is top view of the reduced friction knife blade according to an embodiment of the invention;

FIG. 4B is an enlarged view of the top edge of the reduced friction blade taken from FIG. 4A, according to an embodiment of the invention;

FIG. 5A is a bottom edge or sharpened edge view of the reduced friction blade according to an embodiment of the invention; and

FIG. 5B is an enlarged view of the bottom edge or sharpened edge of the reduced friction blade take from FIG. 5A, according to an embodiment of the invention.

### DETAILED DESCRIPTION

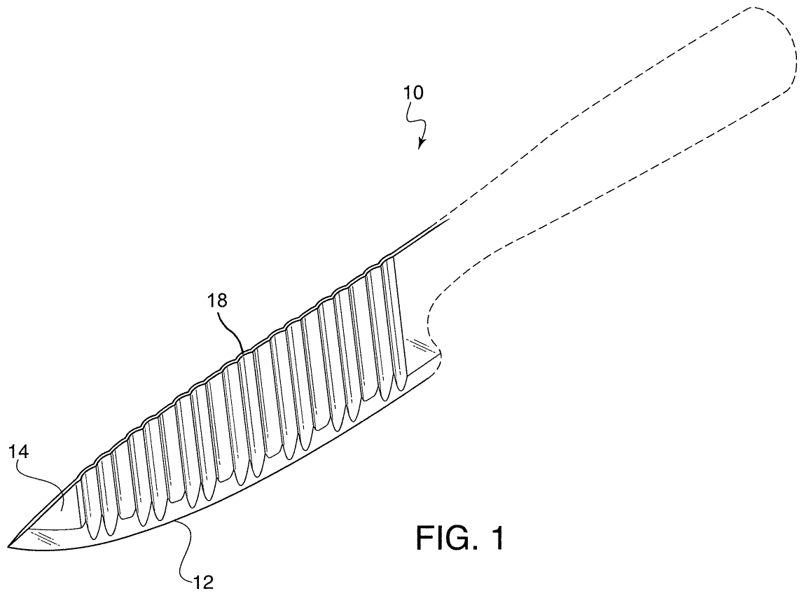

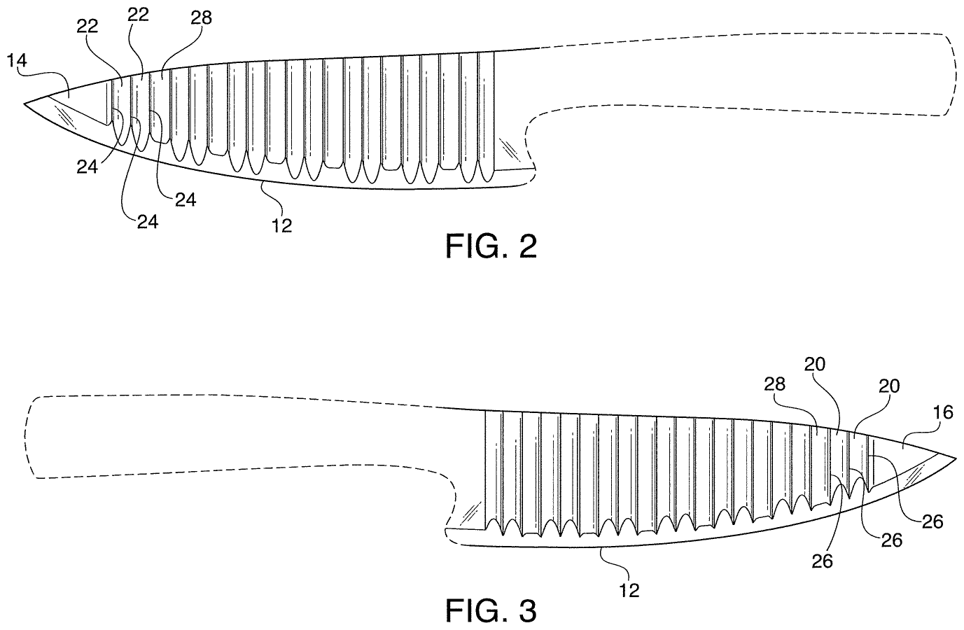

Referring to FIGS. 1-3, the knife blade 10 includes a sharpened edge 12, and two sides, 14 and 16, respectively. In accordance with one preferred implementation, one side 14 includes a plurality of air gaps 30, 32 formed between peaks or points 24 that define valleys 22 and flatter depressions 28a. The other side 16 also includes a plurality of air gaps 34, 36 formed by protrusions 20, pointed depressions 26 and flat depressions 28b.

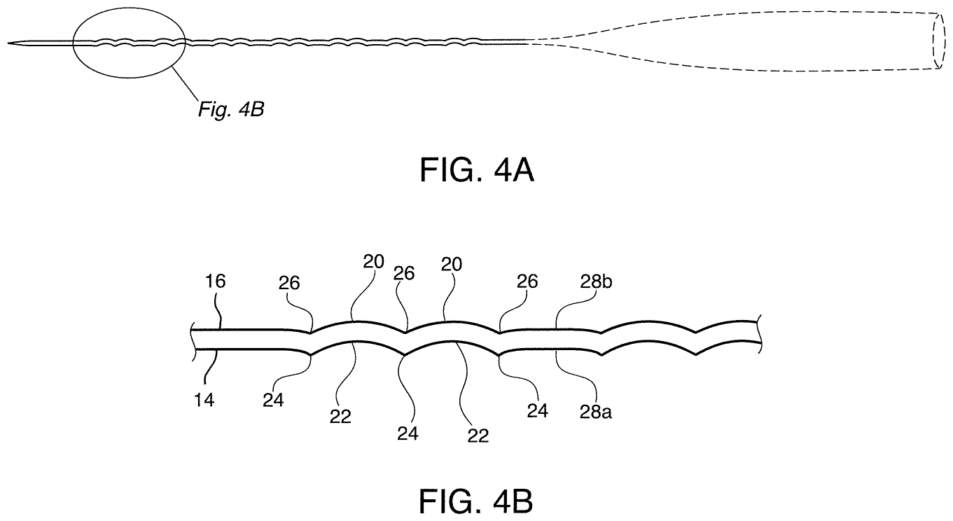

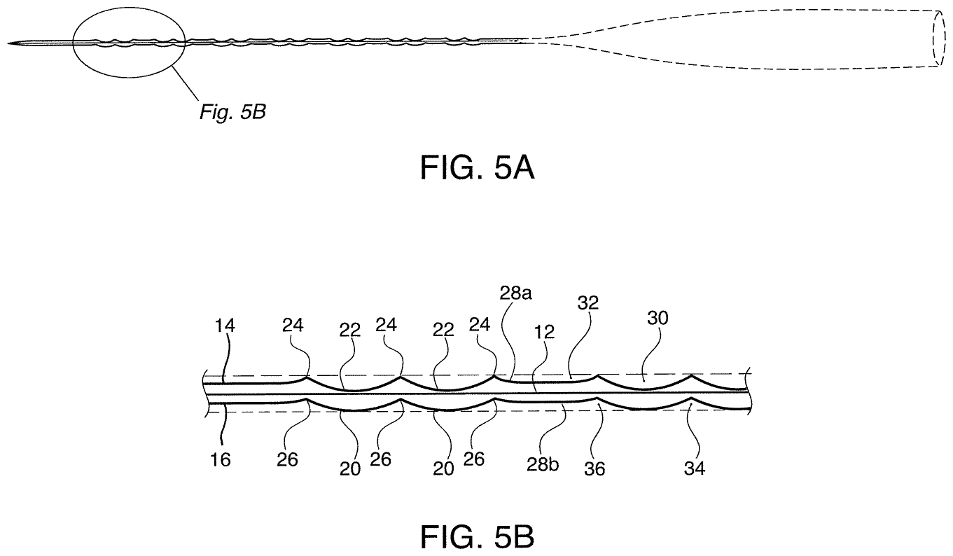

Referring to FIGS. 4A-5B, and in accordance with one embodiment, the valleys 22 can be formed by rounded depressions in the blade with the peaks or points 24 on each side of the same. The same peaks or points 24 further define a less rounded or flattened depression 28a, also positioned between two peaks or points 24. As shown in FIG. 5B, the valleys 22 form air gaps 30 while the less rounded depression 28a forms a different shaped air gap 32 than that of air gap 30. The different “shapes” of air gaps as used herein refers to the volume of air that can be contained within the air gap when using the knife blade to cut food products. It will be appreciated from the drawings that the different shapes of the air gaps clearly refer to the different volumetric sizes of the respective air gaps.

On the other side 16 of the blade, protrusions 20 are formed opposite the valleys 22 and are further defined by pointed depressions 26 formed opposite the peaks or points 24. In this manner, an air gap 34 is formed between the protrusions 20. A further depression 28b relative to the adjacent protrusion 20 is also formed between pointed depressions 26, which further creates a larger air gap 36 between protrusions 20 separated by the depression 28b.

Through this design and the application of irregular and different shaped/sized air gaps 30, 32, 34 and 36, during use of the knife blade, food products contact much less surface area of the knife blade, and as a result friction between the food product and the knife blade is significantly reduced such that the food product falls away from the knife blade as slicing is completed. By way of further example, when a food product is cut using the blade of the present invention, the food product will be sliced and then separated by the peaks/points 24 on side 14, and by the protrusions 20 on side 16. It will become immediately apparent that the food product is in contact with only a small portion of the blade once it is sliced, and through the entire slicing action. Thus, any food drag resulting from the food traveling along the blade surface during the slicing action is completely eliminated by the peaks/points 24 on side 14, and by the protrusions 20 on side 16.

The air gaps 30, 32, 34 and 36 extend from a point immediately adjacent the sharpened edge 12 all the way to and through the top edge 18. By forming the air gaps in the blade itself and extending the same all the way to the top edge, the air between the food product being sliced and the peaks/points 24 and protrusions 20 can never be trapped, and therefore no vacuum or suction can take place during the slicing action. In this manner, food products simply fall off the blade during slicing.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

While particular embodiments and applications of the present disclosure have been illustrated and described, it is to be understood that the present disclosure is not limited to the precise construction and compositions disclosed herein and that various modifications, changes, and variations can be apparent from the foregoing descriptions without departing from the invention as defined in the appended claims.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

What is claimed is:

1. A knife comprising:
a blade having opposing sides, a top edge and a cutting edge;
a first plurality of air gaps formed on one of the opposing sides and being slightly spaced from the cutting edge, wherein some of the first plurality of air gaps have different shapes relative to others of said first plurality of air gaps, and each of said first plurality of air gaps extend all the way to the top edge; and
a second plurality of air gaps formed in the other of the opposing sides and being slightly spaced from the cutting edge, wherein some of the second plurality of air gaps have different shapes relative to others of said second plurality of air gaps and aal of said second plurality of air gaps have different shapes relative to the first plurality of air gaps, the plurality of second air gaps extending all the way to the top edge.

2. A knife comprising:
a blade having a first side and a second opposing side, a cutting edge and a top edge;
a first set of depressions formed in the first side, the first set of depressions being separated by raised peaks and forming first air gaps having a first air volume;
a second set of depressions formed in the first side, the second set of depressions being dispersed among the first set of depressions and also being separated by the raised peaks, the second set of depressions forming second air gaps having a second air volume that is different than the first air volume of the first air gaps;
a first set of protrusions formed on the second side, the first set of protrusions being separated by depressed points, wherein the depressed points between the first set of protrusions form third air gaps having a third air volume that is different than both the first air volume and the second air volume; and
a third set of depressions formed in the second side and being dispersed among the first set of protrusions and also being separated by the depressed points of adjacent first protrusions, the third depressions forming fourth air gaps having a fourth air volume that is different than the first air volume, the second air volume and the third air volume.

3. A knife comprising:
a blade having a first side and a second opposing side, a cutting edge and a top edge;
first air gaps formed on the first side and extending to the top edge, each of the first air gaps having a first air volume;
second air gaps also formed on the first side and extending to the top edge, each of the second air gaps having a second air volume, the second air volume being different than the first air volume;
third air gaps formed on the second side and extending to the top edge, each of the third air gaps having a third air volume; and
fourth air gaps also formed on the second side and extending to the top edge, each of the fourth air gapes having a fourth air volume, the fourth air volume being different than the third air volume.
